(19) United States
(12) Patent Application Publication
(10) Pub. No.: US 2014/0367929 A1
(43) Pub. Date: Dec. 18, 2014

(54) TOOL HOLDER, COLLET AND METHOD TO CLAMP A TOOL IN A TOOL HOLDER

(71) Applicant: Eugen Fahrion GmbH & Co. KG, Kaisersbach (DE)

(72) Inventor: Ulrich Fahrion, Kaisersbach (DE)

(21) Appl. No.: 14/303,728

(22) Filed: Jun. 13, 2014

(30) Foreign Application Priority Data
Jun. 14, 2013 (DE) 10 2013 211 116.9
Feb. 6, 2014 (DE) 10 2014 202 151.0

(51) Int. Cl. B23B 31/20; B23B 31/11

(52) U.S. Cl. CPC B23B 31/20; B23B 31/11; B23B 2231/2008; B23B 2231/2097
USPC 279/42; 29/559; 279/43.1

(57) ABSTRACT

A tool holder includes a collet clamped with a tool, a collet chuck connected to a power tool, and a clamping nut connecting the collet to the collet chuck. At least two groove-shaped material recesses are created in a body of the collet. The at least two recesses extend in a lengthwise direction of the collet body, and starting from an open circumferential surface of the collet body, extend in a radial direction up to a limit stop.

### CROSS-REFERENCE TO RELATED APPLICATIONS

This application claims priority from German Patent Application No. DE 10 2013 211 116.9 filed Jun. 14, 2013 and German Patent Application No. DE 10 2014 202 151.0 filed Feb. 6, 2014, both of which are hereby incorporated by reference herein in their entireties.

### FIELD

The invention relates to a tool holder having a collet that can be clamped with a tool, having a collet chuck for connection to a power tool, and having a clamping nut for connecting the collet to the collet chuck.

### BACKGROUND

Tool holders that have a collet, a collet chuck and a clamping nut serve to hold tools such as milling cutters, drills, thread-cutting taps and the like. The tool is clamped into a so-called collet that can be connected to the tool by screwing the clamping nut to the collet chuck.

Such a tool is described, for example, from European patent specification EP 1 616 647 B1. With this tool holder, a collet is provided that has through-slots in the radial direction, thus forming collet segments that can move in the radial direction. Within the scope prescribed by so-called collet bridging, this mobility makes it possible to hold tools of different diameters. Moreover, such a tool holder has damping properties that are advantageous in terms of a high manufacturing precision and a gentle engagement of the tool into a workpiece. A drawback, however, is that the concentric running precision of such a tool holder is limited.

Another tool holder is described, for instance, from German patent 196 38 808 B4. With this tool holder, a solid collet is provided that is configured as a so-called “shrink collet”. Such a collet exhibits an essentially hollow-cylindrical configuration and has no collet segments that are separated from each other by slots. In order to hold a tool, such a collet has a bore that is a few hundredths of a millimeter smaller than the nominal diameter of the tool. The shrink collet is heated to several hundred degrees centigrade in order to expand the bore in such a way that—if applicable, assisted by an insertion chamfer or centering—a tool shaft that is to be clamped can be inserted. After the tool has cooled off to ambient temperature, the tool is clamped in the shrink collet at a high clamping force. For the final assembly, using a clamping nut, the shrink collet, along with the tool clamped in it, is attached to a collet chuck.

The tool holder known from German patent 196 38 808 B4 yields a high level of concentric running precision, provided that the individual parts of the tool holder have been manufactured with very high precision. However, even in the case of the tiniest of dimensional deviations and/or unfavorable pairings of individual parts, tolerance overlapping can occur, resulting in a poor concentric running and reduced clamping forces of the tool. Another drawback is the time-consuming work preparation and the complex equipment needed in order to heat the shrink collet and to shrink the tool into the shrink collet. Moreover, such a tool holder cannot provide any damping properties. Finally, the shrink collets have to be made of special materials that have to undergo complicated hardening and tempering processes.

### SUMMARY

An aspect of the present invention is a tool holder including a collet clamped with a tool, a collet chuck connected to a power tool, and a clamping nut connecting the collet to the collet chuck. At least two groove-shaped material recesses are created in a body of the collet. The at least two recesses extend in a lengthwise direction of the collet body, and starting from an open circumferential surface of the collet body, extend in a radial direction up to a limit stop.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 a perspective view of an embodiment of a tool holder with a collet;

FIG. 2 a front view of the collet according to FIG. 1;

FIG. 3 an enlarged view of a section designated as III in FIG. 2;

FIG. 4 a front view of another embodiment of a collet;

FIG. 5 an enlarged view of a section designated as V in FIG. 4;

FIG. 6 a front view of another embodiment of a collet;

FIG. 7 an enlarged view of a section designated as VII in FIG. 6;

FIG. 8 a front view of another embodiment of a collet;

FIG. 9 an enlarged view of a section designated as IX in FIG. 8;

FIG. 10 a side view of a pre-assembly group of an embodiment of a tool holder and an embodiment of a pre-assembly device during a first assembly phase;

FIG. 11 a side view of the pre-assembly group and the pre-assembly device according to FIG. 10 during a second assembly phase;

FIG. 12 a side view of an embodiment of a tool holder during a final assembly phase;

FIG. 13 a perspective view of an embodiment of a collet.

### DETAILED DESCRIPTION

Before this backdrop, the present invention is based on the objective of creating a tool holder with which as many of the above-mentioned disadvantages as possible can be avoided.

This objective is achieved according to an embodiment of the invention with a tool holder of the above-mentioned type in that groove-shaped material recesses are created in the body of the collet, whereby said recesses extend in the lengthwise direction of the collet body and, starting from an open circumferential surface of the collet body, extend in the radial direction up to a limit stop.

In contrast to conventional slotted collets, the collet of the tool holder according to the invention does not have any through-slots in the radial direction of the collet body, but rather, it has groove-shaped material recesses that are limited in the radial direction. The material recesses preferably extend over the entire length of the collet body.

The groove-shaped material recesses separate segments of the collet body that are adjacent to each other, whereas material of the collet body that is adjacent to the limit stop of the material recess connects these collet segments to each other. In this manner, a collet can be provided that has a high stability and a high concentric running precision, but that permits only a slight relative mobility between adjacent collet segments, so that the collet according to the invention can also exhibit damping properties.

Moreover, the collet according to the invention makes it possible to use a relatively inexpensive material, for example, a commercially available spring steel that is easy to harden. The choice of this material, in conjunction with the groove-shaped material recesses, imparts the collet with elastic properties by means of which manufacturing tolerances between the collet and the collet chuck can be compensated for.

The geometry of the collet body according to the invention makes it possible to damp oscillations, which is especially advantageous in the case of resonance frequencies.

Preferably, the collet has a tool socket that, at a temperature of 20° C., is undersized relative to the lower tolerance limit for the nominal tool dimension of the collet.

With the collet according to the invention, it is possible to use an undersize that is only slightly smaller than the lower tolerance limit of a nominal tool dimension. Thanks to this slight undersize, collet body segments that are adjacent to each other and connected to each other can be expanded, and a tool can be joined to the collet, so that the tool is held securely in the collet against slipping due to its own weight. The expansion process of the collet body needed for this purpose can take place with small assembly forces or with just a slight warming (for example, no more than 100° C.). The subsequent return of the collet to its previous shape (for example, due to cooling of the collet body) brings about merely a contact of the inner circumferential surface of the collet body against the shank surface of the tool. This contact is sufficient to affix a tool in a collet in such a way that the tool assumes the desired length setting and can then be stored in this state. The actual clamping of the collet to the shank surface of the tool only takes place once the collet, along with the tool, has been placed into the collet chuck and the clamping nut has been screwed to the collet chuck.

Only during the course of this screwing procedure are the collet segments—which are slightly movable relative to each other—clamped to the shank surface of the tool, so that the inner circumferential surface of the collet body cooperates with the shank surface of the tool in such a way that the clamping forces needed for machining a workpiece are exerted onto the workpiece.

With a shrink collet known from the state of the art, a relatively large undersize is necessary so that sufficiently high clamping forces can be generated, even with tools that are at the lower tolerance limit. This is because, with a generally known shrink collet, the clamping forces needed for machining the workpiece are already generated while the shrink collet is being shrink-fit onto the tool; when the unit consisting of the shrink collet and the shrink-fit tool is assembled, this unit is merely attached to a collet chuck, but no further clamping forces are built up. The build-up of such forces is not even possible with conventional solid shrink collets since such a shrink collet has no slots and thus no collet segments that can be moved relative to each other.

The tool holder according to the invention is characterized by a combination of damping properties, high concentric running precision and simple handling. The expansion of the collet needed for joining the collet to the tool can be done with little input of energy, for example, by exposing the collet to hot air.

With the collet body according to the invention, the undersize can amount, for example, to a maximum of 10 micrometers. In order to join the collet to a tool that is at the lower tolerance level, the collet then has to be expanded by a mere 10 μm. In the case of a tool that is at the upper tolerance level, this expanded dimension is larger by the magnitude of the tolerance range of the tool.

In an advantageous manner, the profile of the groove-shaped material recesses remains the same as seen in the lengthwise direction of the collet body. In this manner, an undesired staggering of adjacent collet body segments can be avoided.

Starting from the open circumferential surface, the cross section of the material recesses can become narrower as seen in the radial direction, so that a relatively large movement path of adjacent collet body segments can be provided in the area of the open circumferential surface.

In a preferred embodiment, it is provided that the limit stop of a material recess is formed by the wall surface of a free space that extends in the circumferential direction or tangentially to the circumferential direction. Such a free space causes adjacent collet segments to tilt around an axis that is parallel to the collet axis.

The material recesses can be arranged radially on the outside and can extend from an outer circumferential surface of the collet body up to a limit stop located radially on the inside.

As an alternative or in addition to this, material recesses can be provided that are arranged radially on the inside and that extend from an inner circumferential surface of the collet body up to a limit stop located radially on the outside.

The material recesses that are located radially on the inside and/or located radially on the outside are preferably arranged so as to be distributed regularly over the circumference of the collet body. In particular, at least three material recesses are provided that are arranged along the circumference of the collet body so as to be offset by 120° relative to each other.

If material recesses arranged radially on the outside as well as material recesses arranged radially on the inside are provided, then at least some of these material recesses can be flush with each other as seen in the circumferential direction. In this case, at the height of material recesses that are flush with each other, adjacent collet body segments are connected to each other in a radially extending material area that adjoins the appertaining limit stops of two material recesses that are flush with each other. This results in a high degree of relative mobility between adjacent collet body segments, along with high stability.

It is also possible that, when material recesses arranged radially on the outside as well as material recesses arranged radially on the inside are used, they are offset relative to each other as seen in the circumferential direction. In this manner, a very stable and yet slightly deformable collet is provided that has especially high concentric running precision and nevertheless has a damping effect.

The invention also relates to a method for clamping a tool in a tool holder, especially in a tool holder as described above, comprising the provision of a collet, the expansion of a tool socket of the collet, the arrangement of a tool in the collet, the return of the collet to its previous shape, the arrangement of the collet, along with the tool, on a collet chuck, and the screwing of a clamping nut to the collet chuck, whereby the return of the collet to its previous shape is accompanied by contact of the inner circumferential surface of the collet body with the shank surface of the tool, whereby the tool is securely held in the collet against slipping due to its own weight, and yet it is not clamped, whereby the screwing of the clamping nut is accompanied by clamping the inner circumferential surface of the collet body to the shank surface of the tool, and whereby the clamping forces needed for machining a workpiece are only generated during the course of the clamping of the inner circumferential surface of the collet body to the shank surface of the tool and not already during the course of the establishment of contact of the inner circumferential surface of the collet body with the shank surface of the tool.

The advantages and embodiments described above with reference to the tool holder according to the invention also relate to the method according to the invention.

In another embodiment of the invention, it is provided that the collet has a tool socket that, at a temperature of 20° C., is oversized relative to the lower tolerance limit for the nominal tool dimension of the collet. This makes it possible to insert a tool shank into the tool socket at the standard temperature without the tool socket having to be expanded.

In an especially advantageous embodiment, it is provided that the collet body has collet segments in which no material recesses are provided, that the collet segments are connected to each other by means of segment connection areas, and that the material recesses are arranged in the segment connection areas. As a result, a mechanically stable collet can be obtained whose segment connection areas create a relative mobility between two adjacent collet segments.

A particularly good mobility between adjacent collet segments is obtained when material recesses arranged radially on the inside as well as material recesses arranged radially on the outside are provided alternately in the circumferential direction in the segment connection areas. The term “alternately” refers to an arrangement in which at least one material recess arranged radially on the inside (that is to say, for example, 1 or 2 or 3 material recesses arranged radially on the inside) alternate in the circumferential direction with at least one material recess arranged radially on the outside (that is to say, for example, 1 or 2 or 3 material recesses arranged radially on the outside). For instance, as seen in the circumferential direction, material recesses can be arranged in a segment connection area one behind the other as follows: one material recess arranged radially on the inside, two material recesses arranged radially on the outside, one material recess arranged radially on the inside.

An especially good mobility between adjacent collet body segments is obtained when, as seen in the circumferential direction, material recesses arranged radially on the inside as well as material recesses arranged radially on the outside are arranged so as to overlap each other. This especially applies to the case in which material recesses arranged radially on the inside as well as material recesses arranged radially on the outside are provided alternately in the segment connection areas, as seen in the circumferential direction.

It is especially preferred for there to be exactly three material recesses in one segment connection area, whereby especially a material recess arranged radially on the outside is provided between two material recesses arranged radially on the inside, as seen in the circumferential direction.

Finally, it is advantageous for the material recesses to extend in planes that run in the radial direction, relative to the central axis of the collet. This makes it possible to uniformly clamp the body of the collet to a tool shank and to prevent a clamping-induced twisting of sections of the collet.

The invention also relates to a collet that has the features described above with reference to the tool holder according to the invention.

An embodiment of a tool holder is designated in its entirety by the reference numeral 10. The tool holder 10 serves to hold a tool 12, for example, a drill or a thread-cutting tap.

The tool holder 10 comprises a collet chuck 14 whose rear section 16 can be connected in the generally known manner to a power tool. The front section of the collet chuck 14 can be connected to a collet 20. Here, a preferably conical outer circumferential surface 22 of a collet body 24 of the collet 20 engages by clamping to a conical clamping surface 26 of the collet chuck 14. The clamping forces exerted onto the collet body 24 in this manner are transmitted in the radial direction to a shank surface of the tool 12 that is covered by the collet 20.

In order to generate the above-mentioned clamping forces, a clamping nut 28 is provided that is screwed to the collet chuck 14 and that, in the generally known manner, is in contact with the collet 20 and presses the outer circumferential surface 22 of said collet 20 in the direction of the rear section 16 of the collet chuck 14, so that the outer circumferential surface 22 of the collet 20 and the clamping surface 26 of the collet chuck 14 are clamped to each other.

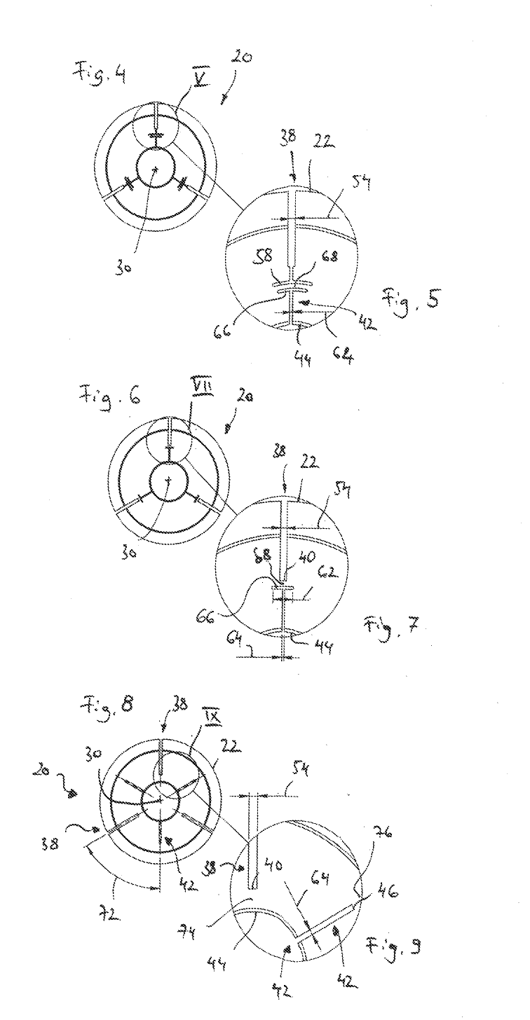

The structure of the collet 20 is explained below with reference to FIGS. 2 and 3. The collet 20 extends along an axis 30 that is identical to the axis of the tool 12.

The collet body 24 preferably comprises three collet segments 32, 34 and 36 that are arranged so as to be distributed regularly over the circumference of the collet 20. The collet segments 32, 34 and 36 are connected to each other, but can be moved relative to each other. For this purpose, the collet 20 has a plurality of groove-shaped material recesses. For example, material recesses 38 arranged radially on the outside are provided which, starting from the outer circumferential surface 22, extend radially to the inside up to a limit stop 40. As an alternative and especially in addition to this, material recesses 42 are provided which extend from the inner circumferential surface 44 of the collet body 24 radially to the outside up to a limit stop 46.

The inner circumferential surface 44 forms the limit stop of a tool socket 48 that extends along the axis 30.

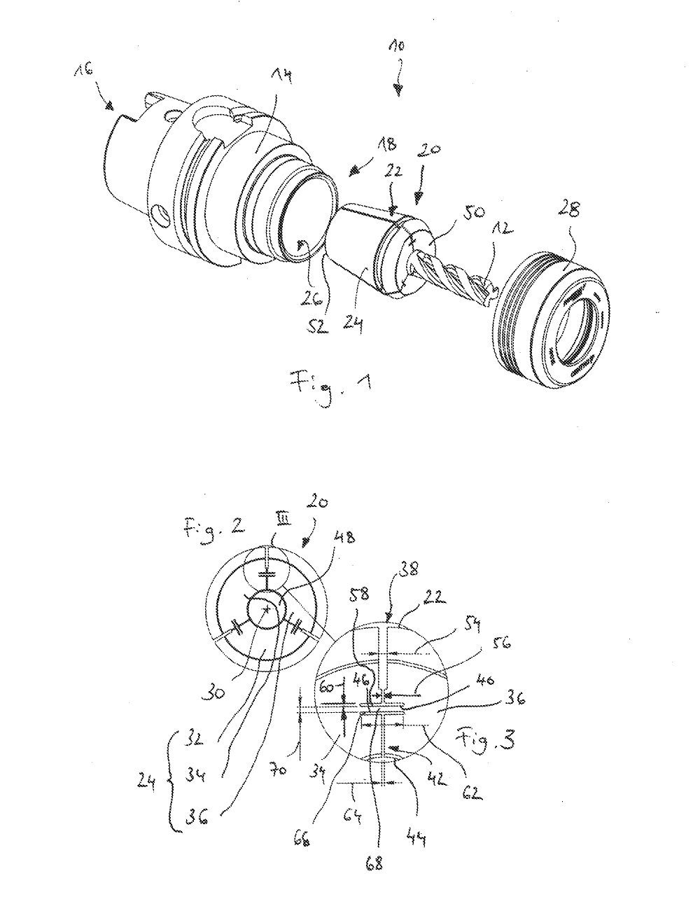

The material recesses 38 and 42 preferably extend along the entire length of the collet 20, that is to say, along the axis 30 between a front 50 and a back 52 (see FIG. 1). Moreover, it is preferable for the material recesses 38 and 42 to have the same profile, that is to say, the same cross section, along their course, as seen parallel to the axis 30.

When it comes to the configuration of the cross section of the material recess, it can become narrower radially towards the inside; for instance, the material recesses 38 arranged radially on the outside become narrower from a width 58 to a width 56. The transition between different widths 54 and 56 can be made so as to be continuous or, as shown in FIG. 3, incremental.

It is possible for the limit stop 40 of the material recess 38 to have a width that corresponds to the minimum width of the material recess 38. However, it is also possible for the limit stop 40 to be formed by the wall surface of a free space 58. This free space 58 preferably extends along a circumference around the axis 30 or, as shown in FIG. 3, tangentially thereto.

The free space 58 has a depth 60 measured in the radial direction and a width 62 measured perpendicular thereto. The width 62 is preferably greater than the depth 60.

The depth 60 corresponds, for example, to the minimum width 56 of the material recess 38.

A width 64 of a material recess 42 arranged radially on the inside can correspond to the minimum width 56 of a material recess 38 arranged radially on the outside.

Optionally, a free space 66 is likewise provided in order to form the limit stop 46 of the material recesses 42 arranged radially on the inside.

In the radial direction between the limit stops 40 and 46 of material recesses 38 and 42 that are flush with each other, there is a material section 68 that connects collet body segments that are adjacent to each other (for example, the segments 34 and 36). The material section 68 has a thickness 70 as measured in the radial direction. This thickness 70 is preferably between approximately 0.4 mm and approximately 3 mm.

Making reference to FIGS. 4 to 9, additional embodiments of collets 20 are described below. Reference is hereby made to the description above pertaining to the collet 20 shown in FIGS. 1 and 2.

In the case of the collet 20 according to FIGS. 4 and 5, the special aspect is that the free spaces 58 and 66 that are adjacent to each other extend along an arc segment. Preferably, the arc size of a free space 58 arranged radially on the outside is larger than the arc size of a free space 66 arranged radially on the inside.

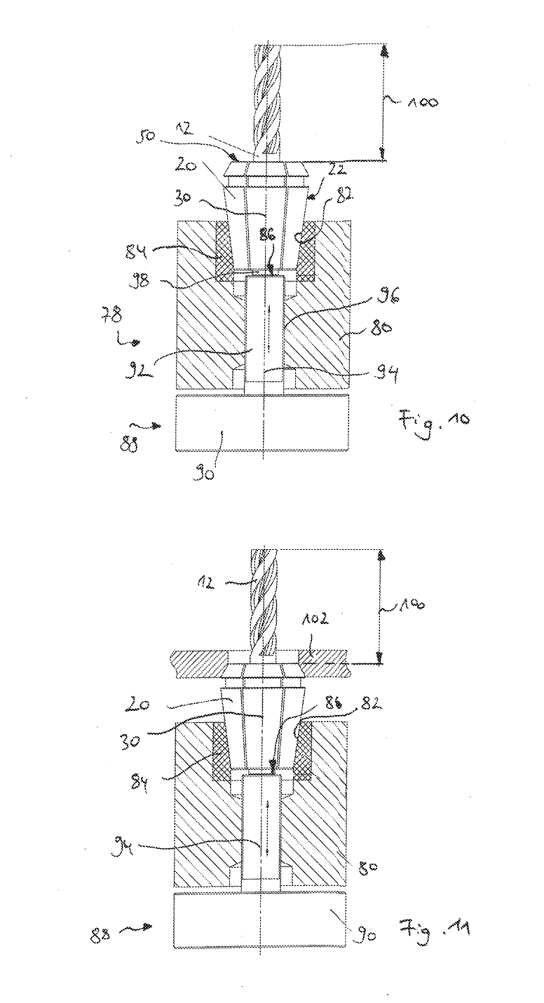

With the collet shown in FIGS. 6 and 7, the special aspect is that, as seen in the radial direction, the width 54 of a material recess 38 arranged radially on the outside remains the same over the entire depth of the material recess 38 up to a limit stop 40. The limit stop 40 is thus formed by the groove bed of the material recess 38. A free space 58 is not provided.

In the embodiments of collets 20 described above, material recesses 38 arranged radially on the outside are provided which are each flush with material recesses 42 arranged radially on the inside, as seen in the circumferential direction.

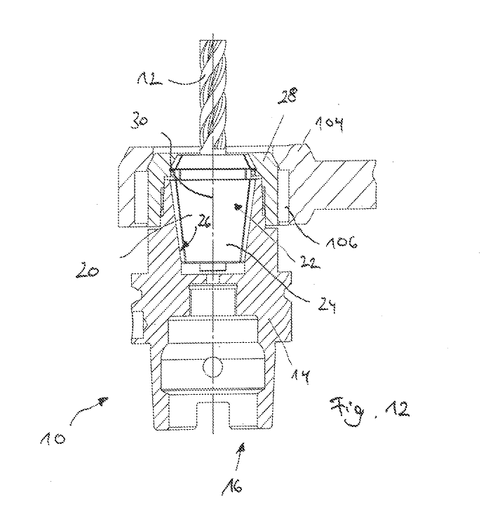

Making reference to FIGS. 8 and 9, an embodiment of a collet 20 is described below, wherein, as seen in the circumferential direction, material recesses 38 arranged radially on the outside and material recesses 42 arranged radially on the inside are offset relative to each other. The material recesses 38 and the material recesses 42 are each regularly offset among each other as well as relative to each other, so that, for example, in each case, a material recess 38 arranged radially on the outside and an adjacent material recess 42 arranged radially on the inside in the circumferential direction are at a distance from each other at an angle 72 of 60°.

The material recesses 38 and 42 each have limit stops 40, 46 whose width corresponds to the continuous widths 54 and 64 of the material recesses 38 and 42, respectively. Between a radially inside limit stop 40 of a material recess 38 arranged radially on the outside and the inner circumferential surface 44, there is a material section 74 that connects collet body segments that are adjacent to each other. Such a connection section 76 is provided between the radially outside limit stop 46 of the material recess 42 arranged radially on the inside and the outer circumferential surface 22. The material sections 74 and 76 are arranged at the height of different circles around the axis 30 of the collet.

In the case of all of the collets 20 described above with reference to FIGS. 1 to 7, the collet body 24 is configured in such a way that all of the collet body segments 32, 34, 36 that are separated by the material recesses 38, 42 are connected to each other along a circumferentially closed path around the axis 30. In the embodiments according to FIGS. 1 to 7, such a connection path is circular (and runs through the material sections 68). In the embodiment shown in FIGS. 8 and 9, the above-mentioned path is also circumferentially closed, but it runs on a wavy line that diverges from a circular line.

Making reference to FIGS. 10 to 12, the installation of a tool 12 in a tool holder 10 is described below. The collet 20 of such a tool holder 10 can have a configuration as described above, for example, with reference to FIGS. 1 to 9.

For the pre-assembly, during which a tool 12 is joined to a collet 20, it is possible to use a pre-assembly device 78. It has a base body 80 whose end facing upwards, relative to the direction of the force of gravity, preferably has a conical holding surface 82 to hold at least one section of the outer circumferential surface 22 of a collet 20. The holding surface 82 is preferably friction-minimized and is especially made up of a plastic insert 84. This can be made, for example, of polytetrafluoroethylene (PTFE, known under the brand name “Teflon”).

The pre-assembly device also comprises a support surface 86 to support the lower end of the tool 12, relative to the direction of the force of gravity. The support surface 86 can be formed integrally with the base body 80. However, it is preferable if the position of the support surface can be adjusted in the direction parallel to the axis 30 of the collet 20. For this purpose, there is a length adjustment means 88 that comprises, for example, an actuating section 90 and an adjusting section 92. The actuating section 90 propels the adjusting section 92, which can rotate around the adjustment axis 94. A thread 96 converts a rotational movement of the length adjustment means 88 into an axial movement along the adjustment axis 94, so that the height of the support surface 86 can be adjusted relative to the holding surface 82.

In order to install a tool 12 in a collet 20, first of all, the outer circumferential surface 22 of the collet 20 (still without the tool 12) is inserted into the holding surface 82, and the holding surface 82 is oriented in a provisional (approximately correct) position. Subsequently, the tool socket 48 (see FIG. 2) of the collet 20 is expanded, for example, by mechanical action, especially by heat input, whereby this heat input can be limited to a maximum of 100° C. Subsequently, a shank surface 98 of the tool 12 can be inserted into the expanded collet 20 until the lower end of the tool 12, relative to the direction of the force of gravity, comes into contact with the support surface 86. This gives rise to a temporary projecting length 100, measured between the front 50 of the collet 20 and a free end of the tool 12 facing away from the shank 98. For purposes of the fine adjustment of the projecting length 100, the length adjustment means 88 can be actuated and the position of the support surface 86 can be changed. The projecting length 100 is increased or decreased, depending on the change of the position of the support surface 86.

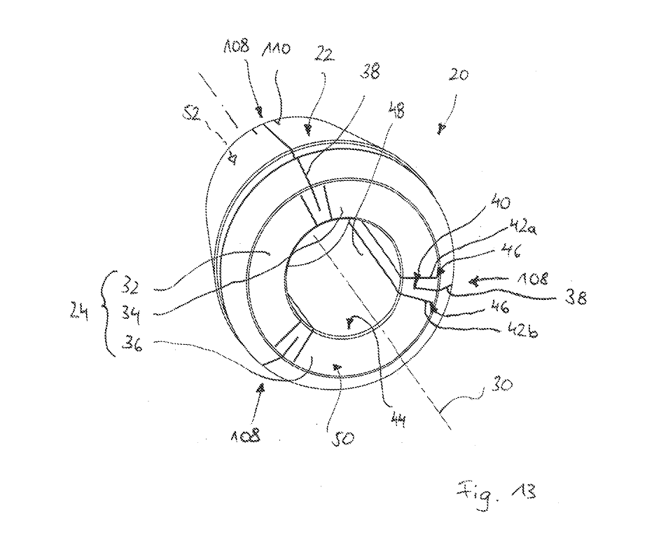

In order to ensure that the relative position between the collet 20 and the holding surface 82 is not also changed during the course of the adjustment of the support surface 86, a hold-down device 102 can be used that presses the collet 20 in the direction of the base body 80 (see FIG. 11).

In order to complete the assembly, the expanded tool socket 48 is returned to its previous shape, for example, in that the collet 20 is no longer subjected to mechanical action, but especially in that the collet 20 is cooled off.

Since the tool socket 48 of the collet 20 is only slightly undersized (relative to the lower tolerance limit of the tool 12 and relative to a cooled state of the collet 20 and of the workpiece 12 at a temperature of 20° C.), the return of the collet 20 to its previous shape, as described above, accounts for the fact that the inner circumferential surface 44 comes into contact only with the shank surface 98 of the tool 12, thus ensuring that the tool 12 cannot slip relative to the collet 20 when the collet 20, along with the tool 12, is removed from the pre-assembly device 78. This makes it possible to store several pre-assembled units, each consisting of a collet 20 and a tool 12, with a precisely adjusted projecting length 100 and, as needed, to connect them to a collet chuck 14.

The installation of a pre-assembled unit consisting of a collet 20 and a tool 12 in a collet chuck 14 is described below making reference to FIG. 12. The collet 20, along with the tool 12, which is secured against slipping, is inserted into the conical clamping surface 26 of the collet chuck 14 in such a way that the outer circumferential surface 22 of the collet is in front. Subsequently, the clamping nut 28 is screwed onto the collet chuck 14 which, in turn, presses the collet 20 in the direction over the rear end 16 of the collet chuck 14 in a generally known manner. As a result, the conical clamping surface 26 exerts clamping forces directed radially towards the inside onto the collet body 24 and onto the collet body segments 32, 34, 36 (see FIG. 2). In this manner, clamping forces are generated that clamp the collet chuck 14 to the collet 20 as well as the collet 20 to the tool 12.

A conventional torque wrench 104 can be used to apply the above-mentioned clamping forces. It preferably has rollers 106 for making contact with the clamping nut 28.

The clamping forces exerted on the tool 12 during the course of the screwing of the clamping nut 28 to the collet chuck 14 amount to many times the contact forces that act on the shank surface 98 of the tool 12 due to the return of the collet to its previous shape during the course of the joining of the tool 12 to the collet 20. In the case of the pre-assembly unit consisting of the collet 20 and the tool 12, the slipping torque of the tool 12 around the axis 30 relative to the collet 20 is for example, about 10 Nm at the maximum. Such a slipping torque would be too low to allow a workpiece to be machined. Workpiece machining is only possible once the collet 20 has been clamped to the tool 12 as described above with reference to FIG. 12. After the clamping of the tool 12 with the collet 20, the slipping torque around the axis 30 is, for example, between about 80 Nm and 300 Nm (examples of values for tools 12 having a diameter of 10 mm to 20 mm).

A preferred embodiment of a collet 20 is shown in FIG. 13. The collet body segments 32, 34, 36 of this collet are connected to each other by means of segment connection areas 108. The collet body segments 32, 34, 36 each extend over an angular range of, for example, 90° to 110°, and they do not have any material recesses 38, 40. These are preferably arranged exclusively in the segment connection areas 108 that each extend, for instance, over an angular range of 10° to 30°.

Within a segment connection area 108, there are several, especially three material recesses 38, 42. Preferably, in each segment connection area 108, there are two material recesses 42a and 42b arranged radially on the inside, between which there is a material recess 38 arranged radially on the outside.

Preferably, the material recesses 38, 42a, 42b are formed by slot-like grooves that extend in planes that are radial with respect to the collet axis 30.

The material recesses 38 arranged radially on the outside extend over the entire length of the collet 20 between the front 50 and the rear 52. Starting from the outer circumferential surface 22 up to the limit stop 40, the material recesses 38 have a penetration depth, measured in the radial direction, that preferably amounts to between approximately 50% and approximately 90% of the wall thickness of the collet 20, measured in the radial direction. The material recesses 42a, 42b arranged radially on the inside extend over the entire length of the collet 20 between the front 50 and the rear 52. Starting from the inner circumferential surface 44 up to the limit stop 46, the material recess has a penetration depth, measured in the radial direction, that preferably amounts to between approximately 50% and approximately 90% of the wall thickness of the collet 20, measured in the radial direction.

In a preferred embodiment, it is provided that the material recesses 42a, 42b pass through the entire wall thickness of the collet 20 in a partial area 110. The partial area 110 is especially adjacent to the rear 52 of the collet and, as seen in the direction of the central collet axis 30, it preferably extends over a maximum of 20% of the length of the collet 20.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A tool holder comprising:
a collet configured to be clamped with a tool;
a collet chuck connectable to a power tool; and
a clamping nut connecting the collet to the collet chuck,
wherein at least two groove-shaped material recesses are created in a body of the collet, the at least two recesses extending in a lengthwise direction of the body and, starting from an open circumferential surface of the body, extending in a radial direction up to a limit stop.

2. The tool holder recited in claim 1, wherein the collet has a tool socket that, at a temperature of 20° C., is undersized relative to a lower tolerance limit for a nominal tool dimension of the collet.

3. The tool holder recited in claim 2, wherein the undersize amounts to a maximum of 10 micrometers.

4. The tool holder recited in claim 1, wherein profiles of the at least two groove-shaped material recesses remain the same in the lengthwise direction of the collet body.

5. The tool holder recited in claim 1, wherein, starting from the open circumferential surface, a cross section of at least one of the material recesses becomes narrower in the radial direction.

6. The tool holder recited in claim 1, wherein the limit stop of the at least two material recesses is formed by the wall surface of a free space that extends in a circumferential direction or tangentially to the circumferential direction.

7. The tool holder recited in claim 1, wherein at least one of the material recesses is arranged radially on the outside and extends from an outer circumferential surface of the collet body up to a limit stop located radially on the inside.

8. The tool holder recited in claim 1, wherein at least one of the material recesses is arranged radially on the inside and extends from an inner circumferential surface of the collet body up to a limit stop located radially on the outside.

9. The tool holder recited in claim 8, wherein at least one material recess arranged radially on the outside and at least one material recess arranged radially on the inside are flush with each other in the circumferential direction.

10. The tool holder recited in claim 7, wherein at least one material recess arranged radially on the outside and at least one material recess arranged radially on the inside are offset relative to each other in the circumferential direction.

11. The tool holder recited in claim 1, wherein the collet has a tool socket that, at a temperature of 20° C., is oversized relative to the lower tolerance limit for the nominal tool dimension of the collet.

12. The tool holder recited in claim 1, wherein the collet body has at least two collet segments in which no material recesses are provided, the at least two collet segments connected to each other by means of segment connection areas, wherein at least two material recesses are arranged in the segment connection areas.

13. The tool holder recited in claim 12, wherein at least one material recess arranged radially on the inside and at least one material recess arranged radially on the outside are provided alternately in the circumferential direction in the segment connection areas.

14. The tool holder recited in claim 1, wherein, at least one material recess is arranged radially on the inside and at least one material recess is arranged radially on the outside so as to overlap each other in the circumferential direction.

15. The tool holder recited in claim 14, wherein the segment connection area has exactly three material recesses, and wherein one material recess is arranged radially on the outside between two material recesses arranged radially on the inside in the circumferential direction.

16. The tool holder recited in claim 1, wherein at least one material recess extends in at least one plane in the radial direction, relative to a central axis of the collet.

17. A method for clamping a tool in a tool holder comprising:
providing a collet;
expanding a tool socket of the collet;
arranging a tool in the collet, the tool being securely held in the collet against slipping without being clamped;
returning the collet to its previous shape, wherein when the collet is returned to its previous shape, an inner circumferential surface of the collet body contacts a shank surface of the tool;
arranging the collet and the tool on a collet chuck; and
screwing a clamping nut to the collet chuck,
wherein when the clamping nut is screwed, the inner circumferential surface of the collet body is clamped to the shank surface of the tool, such that the clamping forces needed for machining a workpiece are only generated during the course of the clamping of the inner circumferential surface of the collet body to the shank surface of the tool and not when the inner circumferential surface of the collet body contacts the shank surface of the tool.

18. A collet configured to be clamped with a tool comprising:
at least two groove-shaped material recesses created in a body of the collet, the at least two recesses extending in a lengthwise direction of the body and, starting from an open circumferential surface of the body, extending in a radial direction up to a limit stop.
